(19) United States
(12) Patent Application Publication
(10) Pub. No.: US 2002/0109911 A1
(43) Pub. Date: Aug. 15, 2002

(54) Method of optical amplification, an optical amplifier and an optical resonator for optical amplifier

(76) Inventor: Yukio Fukuda, Kyoto City (JP)

Correspondence Address: STOEL RIVES LLP, 900 SW FIFTH AVENUE, SUITE 2600, PORTLAND, OR, 97204, US

(21) Appl. No.: 10/013,814

(22) Filed: Dec. 7, 2001

(30) Foreign Application Priority Data
Dec. 8, 2000 (JP) 2000-373679

(51) Int. Cl. H01S 3/00

(52) U.S. Cl. 359/346

(57) ABSTRACT

A monochromatic continuous light emitted from a laser source is introduced into an optical resonator, and resonated and amplified between reflecting mirrors provided in the optical resonator. An optoacoustic element controller applies a pulsed high frequency electric signal to an optoacoustic element so that the amplified monochromatic continuous light is pulsed through the optoacoustic element. The thus obtained pulsed light is diffracted in an oblique direction and taken out of the optical resonator to the outside.

### BACKGROUND OF THE INVENTION

1. Field of the Invention

This invention relates to a method of optical amplification, an optical amplifier and an optical resonator and, more particularly, to a method of optical amplification, an optical amplifier and an optical resonator suitable for various laser apparatus and various optical instruments.

2. Description of Related Art

A single-mode continuous-wave light source can provide a monochromatic continuous light with a remarkably narrow spectral line width. However, since the monochromatic continuous light is relatively small in amplitude, it is required to be amplified by an optical amplifier depending on its use.

A conventional optical amplifier has an amplifying medium therein. Pumping energy is delivered to the amplifying medium from an external source to excite the amplifying medium, and the monochromatic continuous light to be amplified is introduced into the excited amplifying medium.

Since the amplifying medium has an inherent limited amplifying wavelength region, it may be necessary to exchange the amplifying medium for another one, depending on the wavelength of the monochromatic continuous light. Therefore, it may happen that a suitable amplifying medium cannot be provided for some wavelengths of monochromatic continuous light.

Moreover, since the above conventional optical amplifier including the amplifying medium therein may emit amplified monochromatic continuous light accompanied by spontaneous emissions of unnecessary light, another instrument may be required for eliminating the unnecessary light. Therefore, the entire optical amplifier may have a complicated overall structure.

### SUMMARY OF THE INVENTION

It is an object of the present invention to provide a new method of optical amplifier to mitigate the above problem resulting from the use of the amplifying medium.

For achieving the above object, this invention relates to a method optical amplification comprising the steps of:

introducing monochromatic continuous light from a laser source into an optical resonator;

reflecting the continuous light between two reflecting mirrors provided at both ends of the optical resonator, thereby to amplify the continuous light;

passing the thus obtained amplified continuous light through an optoacoustic element installed in the optical resonator to which a pulsed high frequency electric signal is applied, thereby to pulse the amplified continuous light; and

taking the thus obtained pulsed light out of the optical resonator to the outside.

Moreover, this invention relates to an optical amplifier comprising a laser source to emit a single wavelength light and an optical resonator having an optoacoustic element therein and reflecting mirrors at both ends therein.

Then, this invention also relates to an optical amplification comprising an optoacoustic element therein and reflecting mirrors at both ends therein.

The inventors have undertaken intense studies in an effort to develop a new method of optical amplification and a new optical amplifier without the above-described disadvantages. As a result, they have found that the above-mentioned optical resonator can amplify the monochromatic continuous light irrespective of its wavelength, differently from the above-described prior art amplifying medium. Therefore, the above-mentioned method of optical amplification and optical amplifier using the optical resonator can amplify the monochromatic continuous light irrespective of its wavelength to mitigate the above-described problems associated with the amplifying medium.

According to the present invention, monochromatic continuous light emitted from a given laser source is introduced into the optical resonator of the present invention and resonates within the optical resonator having the reflecting mirrors to obtain an amplified monochromatic continuous light. The amplified monochromatic continuous light is pulsed by the optoacoustic element to which a given pulsed high frequency electric signal is applied. The thus obtained monochromatic pulsed light is diffracted in an oblique direction as a result of the optoacoustic effect of the optoacoustic element and is taken out through a window or an optical fiber installed at the optical resonator.

In this case, the monochromatic continuous light propagates back and forth between the reflecting mirrors to resonate within the optical resonator and is amplified. When the diffraction efficiency of the optoacoustic element is set to 100%, the monochromatic continuous light is pulsed so as to have a pulse width of less than or equal to the round-trip time of the light in the optical resonator. The maximum pulse width is represented by “2L/c” (second), provided that the length of the optical resonator is “L” and the velocity of light is “c”.

In place of the above-mentioned optoacoustic element, an electro-optical element and a polarizing beam splitter may be employed. In this case, a given direct current signal is delivered to the electro-optical element, and thus, the amplified monochromatic continuous light at the electro-optical element is changed in its polarization condition and pulsed. Then, the thus obtained pulsed light having the changed polarization condition is reflected in an oblique direction by the polarizing beam splitter and is taken out to the outside.

In a preferred embodiment of the present invention, an electrostrictive element is preferably provided at either of the reflecting mirrors at both ends of the optical resonator. When a given voltage is applied to the electrostrictive element from an external electric power supply, the electrostrictive element is expanded or shrunk due to the electrostrictive effect. Therefore, the position of the reflecting mirror having the electrostrictive element can be controlled.

Generally, the wavelength of the monochromatic continuous light from the laser source fluctuates with time and the length of the optical resonator fluctuates due to the temperature change and the vibration in the optical resonator. Therefore, according to the preferred embodiment of the present invention, if either of the reflecting mirrors provided at both ends of the optical resonator has the electrostrictive element, the position of the one reflecting mirror is controlled automatically by the electrostrictive element and thus, the resonance condition of the monochromatic continuous light is always maintained. As a result, the above-mentioned effect of the present invention is always provided.

### BRIEF DESCRIPTION OF THE DRAWING

For better understanding of the present invention, reference is made to the attached drawing, wherein

FIG. 1 is a structural view of an optical amplifier according to the present invention.

### DETAILED DESCRIPTION OF PREFERRED EMBODIMENTS

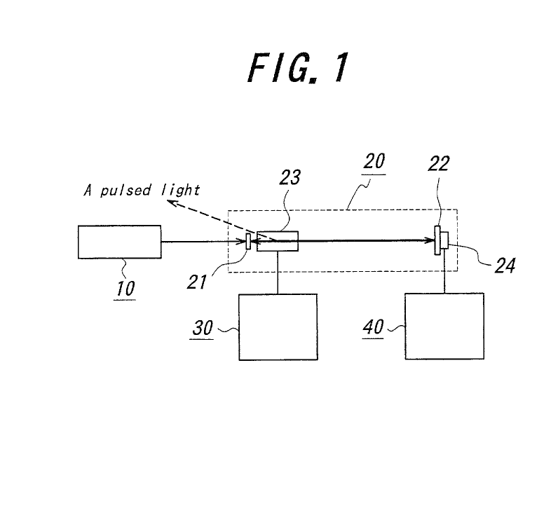

This invention will be described in detail with reference to FIG. 1, which is a structural view of an optical amplifier according to the present invention. With reference to FIG. 1, an optical amplifier includes a laser source 10 and an optical resonator 20. Reflecting mirrors 21 and 22 are provided at both ends of the optical resonator 20, and an optoacoustic element 23 is provided at the forward area of the reflecting mirror 21. Moreover, an electrostrictive element 24 is provided at the rear surface of the reflecting mirror 22.

An optoacoustic element controller 30 is connected to the optoacoustic element 23 and applies a high frequency electric signal to the optoacoustic element 23. Moreover, an electrostrictive element controller 40 is connected to the electrostrictive element 24.

A monochromatic continuous light emitted from the laser source 10 is introduced into the optical resonator 20. The light resonates and is amplified as it propagates between the reflecting mirrors 21 and 22. The amplifying ratio of the optical resonator 20 is represented as about 1/(1−R), provided that the reflection coefficients of the reflecting mirrors 21 and 22 are “K” and “1”, respectively. Therefore, if the reflection coefficient R is set to 99%, the amplification ratio 1/(1−R) equals 100. As a result, in this case, the amplitude of the monochromatic continuous light is amplified by 100 times.

If the reflection coefficient R of the reflecting mirror 21 is changed arbitrarily, the amplification ratio 1/(1−R) can be controlled freely. Practically, if the reflecting mirror 21 is composed of a commercially available reflecting mirror, the amplification ratio can be set up to 10,000.

When a given high frequency electric signal is applied to the optoacoustic element 23 from the optoacoustic element controller 30, the thus obtained amplified monochromatic continuous light is pulsed and diffracted in an oblique direction through the optoacoustic element 23. Therefore, the amplified continuous light can be taken out, as a pulsed monochromatic light, of an optical window or an optical fiber provided in the reflected direction to the outside.

Moreover, when a given voltage is applied to the electrostrictive element 24 provided on the rear surface of the reflecting mirror 22 from the electrostrictive element controller 40, the electrostrictive element 24 can control the position of the reflecting mirror 22 by the electrostrictive effect. As mentioned above, the wavelength of the monochromatic continuous light fluctuates slightly with time, and the length of the optical resonator 20 fluctuates due to the temperature change and the vibration in the optical resonator 20. Therefore, as mentioned above, if the electrostrictive element 24 is provided at the reflecting mirror 22, the position of the reflecting mirror 22 is controlled, so that the resonance condition in the optical resonator 20 can be maintained for a long time and the monochromatic continuous light can be amplified stably for a long time.

Moreover, if the diffraction efficiency of the optoacoustic element 23 is set to 100%, the amplified monochromatic continuous light is converted to a pulsed light having a pulse width equal to the back and forth period of the continuous light in the optical resonator 20. If the diffraction efficiency of the optoacoustic element 23 is decreased, the pulse width can be changed. For example, if the diffraction efficiency of the optoacoustic element 23 is decreased from 100% to 10%, the attenuation time of the monochromatic continuous light in the optical resonator 20 becomes equal to 10 times the period of the back and forth period thereof in the optical resonator 20. As a result, the time period of the thus obtained pulsed light can be elongated by 10 times and the pulsed light can have a 10 times pulse width.

When the diffraction efficiency of the optoacoustic element 23 is decreased, the amplified monochromatic pulsed light is attenuated exponentially, but if the amplitude of the high frequency electric signal to be applied to the optoacoustic element 23 is changed with time, the amplified monochromatic pulsed light can have various shapes, such as a rectangular shape.

Moreover, as mentioned above, an electro-optical element and a polarizing beam splitter may be employed in place of the optoacoustic element 23. In this case, the pulse width of the pulsed light can be adjusted by changing the temporal width of a pulsed current electric signal to be applied to the electro-optical element. Moreover, the pulse shape of the pulsed light can be adjusted by changing the amplitude of the pulsed direct current electric signal.

The optoacoustic element 23 and the electrostrictive element 24 of the present invention each may be composed of commercially available devices. Moreover, the laser source 10 may be of a conventional type that is suitable for the intended purpose. The optoacoustic element controller 30 and the electrostrictive element controller 40 each may have high frequency electric power supplies, direct current electric power supplies, controllers and additional instruments, and may be of any structural configuration.

Although the present invention was described in detail with reference to the above example, this invention is not limited to the above disclosure and every kind of variation and modification may be made without departing from the scope of the present invention.

As explained above, according to the optical amplifying method, the optical amplifier and the optical resonator for the optical amplifier, the monochromatic continuous light can be amplified within a wide wavelength range without the unnecessary light emission due to the spontaneous emission. Such performance achievements cannot be realized from the conventional optical amplifying method and optical amplifier using the optical resonator having the amplifying medium therein.

What is claimed is:

1. An optical amplifying method comprising the steps of:
introducing into an optical resonator a continuous light having a single wavelength from a laser source;
reflecting the continuous light between two reflecting mirrors provided at both ends of the optical resonator, thereby to amplify the continuous light and obtain amplified continuous light;
passing the amplified continuous light through an optoacoustic element installed in the optical resonator to which a pulsed high frequency electric signal is applied, thereby to pulse the amplified continuous light; and
directing the thus obtained pulsed light out of the optical resonator to the outside.

2. An optical amplifying resonator as defined in claim 1, wherein the optical resonator has a response length, and further comprising the step of controlling the resonance length of the optical resonator by applying a given voltage to an electrostrictive element provided at either one of the two reflecting mirrors.

3. An optical amplifying method as defined in claim 1, wherein the pulsed light has a pulse width and optoacoustic element has a diffraction efficiency, and further comprising the step of controlling the pulse width of the pulsed light by changing the diffraction efficiency of the optoacoustic element.

4. An optical amplifying method as defined in claim 3, wherein the pulsed light has a pulse shape and the high frequency electric signal has an amplitude, and wherein the pulse shape of the pulsed light is adjusted by changing the amplitude of the high frequency electric signal to be applied to the optoacoustic element with time.

5. An optical amplifying method as defined in claim 2, wherein the pulsed light has a pulse width and optoacoustic element has a diffraction efficiency, and further comprising the step of controlling the pulse width of the pulsed light by changing the diffraction efficiency of the optoacoustic element.

6. An optical amplifying method as defined in claim 5, wherein the pulsed light has a pulse shape and the high frequency electric signal has an amplitude, and wherein the pulse shape of the pulsed light is adjusted by changing the amplitude of the high frequency electric signal to be applied to the optoacoustic element with time.

7. An optical amplifying method comprising the steps of:
introducing into an optical resonator a continuous tight having a single wavelength from a laser source;
reflecting the continuous light in between two reflecting mirrors provided at both ends of the optical resonators, thereby to amplify the continuous light and obtain amplified continuous light, the amplified continuous light having a polarization condition;
passing the amplified continuous light through an electro-optical element installed in the optical resonator to which a pulsed direct current electric signal is applied, thereby to change the polarization condition of the amplified continuous light; and
directing the amplified continuous light having the changed polarization condition, as pulsed light, out of the optical resonator through a polarizing beam splitter installed in the optical resonator.

8. An optical amplifying method as defined in claim 7, wherein the optical resonator has a resonance length, and further comprising the step of controlling the resonance length of the optical resonator by applying a given voltage to an electrostrictive element provided at either one of the two reflecting mirrors.

9. An optical amplifying method as defined in claim 7, wherein the pulsed light has a pulse width, and further comprising the step of controlling the pulse width of the pulsed light by changing the direct current electric signal of the electro-optical element.

10. An optical amplifying method as defined in claim 9, wherein the pulsed light has a pulse shape and the pulsed direct current electric signal has an amplitude, and wherein the pulse shape of the pulsed light is adjusted by changing the amplitude of the pulsed direct current electric signal in temporal width to be applied to the optoacoustic element with time.

11. An optical amplifying method as defined in claim 8, wherein the pulsed light has a pulse width, and further comprising the step of controlling the pulse width of the pulsed light by changing the direct current electric signal of the electro-optical element.

12. An optical amplifying method as defined in claim 11, wherein the pulsed light has a pulse shape and the pulsed direct current electric signal has an amplitude, and wherein the pulse shape of the pulsed light is adjusted by changing the amplitude of the pulsed direct current electric signal in temporal width to be applied to the optoacoustic element with time.

13. An optical amplifier comprising a laser source to emit a single wavelength of light and an optical resonator having an optoacoustic element therein and reflecting mirrors at both ends therein.

14. An optical amplifier as defined in claim 13, further comprising an electrostrictive element at either of the reflecting mirrors provided in the optical resonator.

15. An optical amplifier comprising a laser source to emit a single wavelength of light, and an optical resonator having an electro-optical element and a polarizing beam splitter therein and reflecting mirrors at both ends therein.

16. An optical amplifier as defined in claim 15, further comprising an electrostrictive element at either one of the reflecting mirrors provided in the optical resonator.

17. An optical resonator for optical amplifying comprising an optoacoustic element therein and reflecting mirrors at both ends therein.

18. An optical resonator for optical amplifying as defined in claim 17, further comprising an electrostrictive element at either one of the reflecting mirrors provided therein.

19. An optical resonator for optical amplifying comprising an electro-optical element and a polarizing beam splitter therein, and reflecting mirrors at both ends therein.

20. An optical resonator for optical amplifying as defined in claim 19, further comprising an electrostrictive element at either one of the reflecting mirrors provided therein.
